(19) United States
(12) Patent Application Publication
(10) Pub. No.: US 2009/0203436 A1
(43) Pub. Date: Aug. 13, 2009

(54) Betting system for sharing progressive bonus and control method thereof

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/216,886

(22) Filed: Jul. 11, 2008

Related U.S. Application Data
(60) Provisional application No. 61/027,689, filed on Feb. 11, 2008.

(51) Int. Cl. A63F 13/00

(52) U.S. Cl. 463/27

(57) ABSTRACT

In a betting system, roulette games or horse racing games can be executed at one terminal and also tickets for betting events can be purchased. In addition, a progressive bonus count value is accumulated into a progressive bonus counter at each game execution and also a progressive bonus count value is accumulated into the progressive bonus counter at each sale of the tickets. Then all or part of the progressive bonus count value accumulated in the progressive bonus counter will be awarded when an award has been achieved in executing the games or in purchasing the tickets. Therefore, more awards can be provided to a player.

### CROSS-REFERENCE TO RELATED APPLICATION

This application is based upon and claims the benefit of U.S. Provisional Patent Application Ser. No. 61/027,689, filed on Feb. 11, 2008; the entire contents of which are incorporated herein by reference for all purposes.

### BACKGROUND OF THE INVENTION

1. Field of the Invention

The present invention relates to a betting system including a gaming device for executing games using medals, coins, bills or the like, a betting device for placing a bet on a betting event and a control method of the betting system.

2. Description of Related Art

Relating to a betting apparatus, a betting method for sports betting is described in WO/01/077861 or WO/95/22883. In addition, a gaming machine, which is connected with plural client terminals, a central controller and a communal display unit, is disclosed as a related gaming device, is disclosed in US2005/0059474 A1, US2005/0282618 A1 and US2005/0218590 A1.

However, conventionally, betting events such as sports and gaming devices have been treated separately and then dividends of services provided to a player have been limited. Therefore, a betting system, which has an entertaining feature with associated dividends between betting events and a gaming device, is desired to be produced.

### SUMMARY OF THE INVENTION

A first aspect of the present invention provides a betting system which includes a display for displaying images, a counter for counting a count value for progressive bonus, and a controller. The controller is operable to (A) execute a unit game repeatedly, accumulate the count value at each game execution, and provide an award corresponding to all or part of the count value when the unit game has brought a winning of the progressive bonus. The controller is also operable to (B) sell a ticket for an expected result of a betting event, accumulate the count value and determine whether or not the progressive bonus is to be awarded at each ticket sale, and provide an award corresponding to all or part of the count value when it has been determined that the progressive bonus is to be awarded.

A second aspect of the present invention provides a betting system which includes a display for displaying images, a counter for counting a count value for progressive bonus, and a controller. The controller is operable to (a) execute a unit game after accepting a bet amount, and provide an award when the unit game has brought a winning, (b) accumulate part of the bet amount into the counter, (c) provide an award corresponding to all or part of the count value when the unit game has brought a progressive bonus winning, (d) output a ticket for an expected result of a betting event after accepting a wager, (e) accumulate part of the wager into the counter, and (f) determine whether or not the progressive bonus is to be awarded at accepting the wager, and provide an award corresponding to all or part of the count value when it has been determined that the progressive bonus is to be awarded.

A third aspect of the present invention provides a controlling method of a betting system which includes: executing unit game repeatedly, and accumulating a count value for progressive bonus counted by a counter at each game execution; accumulating the count value at each ticket sale for an expected result of a betting event; providing an award corresponding to all or part of the count value when the unit game has brought a progressive bonus winning; and determining whether or not the progressive bonus is to be awarded at each ticket sale, and providing an award corresponding to all or part of the count value when it has been determined that the progressive bonus is to be awarded.

### BRIEF DESCRIPTION OF THE DRAWINGS

FIG. 1 is a flow-chart showing a process flow by a controller in an embodiment of betting system according to the present invention;

FIG. 2 is a perspective view showing general components in the embodiment of the betting system according to the present invention;

FIG. 3 is a perspective view showing a configuration of a terminal in the embodiment of the betting system according to the present invention;

FIG. 4 is a connection diagram in the embodiment of the betting system according to the present invention;

FIG. 5 is an explanatory diagram of a roulette device applied to the embodiment of the betting system according to the present invention;

FIG. 6 is a block diagram showing an internal configuration of a roulette controller in the embodiment of the betting system according to the present invention;

FIG. 7 is a block diagram showing an internal configuration of the roulette device applied to the embodiment of the betting system according to the present invention;

FIG. 8 is a block diagram showing an internal configuration of a horse racing game controller in the embodiment of the betting system according to the present invention;

FIG. 9 is a block diagram showing an internal configuration of a display controller in the embodiment of the betting system according to the present invention;

FIG. 10 is a block diagram showing an internal configuration of a progressive bonus controller in the embodiment of the betting system according to the present invention;

FIG. 11 is a block diagram showing an internal configuration of an intermediary controller in the embodiment of the betting system according to the present invention;

FIG. 12 is a block diagram showing an internal configuration of the terminal in the embodiment of the betting system according to the present invention;

FIG. 13 is a display example displayed at the terminal in the embodiment of the betting system according to the present invention;

FIG. 14 is a display example displayed at the terminal in the embodiment of the betting system according to the present invention;

FIG. 15 is a display example displayed at the terminal in the embodiment of the betting system according to the present invention;

FIG. 16 is a display example displayed at the terminal in the embodiment of the betting system according to the present invention;

FIG. 17 is a display example displayed at the terminal in the embodiment of the betting system according to the present invention;

FIG. 18 is a flow-chart of roulette game execution processing in the embodiment of the betting system according to the present invention;

FIG. 19 is a flow-chart of horse racing game execution processing in the embodiment of the betting system according to the present invention;

FIG. 20 is a flow-chart of extra race execution processing in the embodiment of the betting system according to the present invention;

FIG. 21 is a flow-chart of ticket sales processing in the embodiment of the betting system according to the present invention;

FIG. 22 is a betting screen at an execution of a roulette game in the embodiment of the betting system according to the present invention;

FIG. 23 is a betting screen at an execution of a horse racing game in the embodiment of the betting system according to the present invention;

FIG. 24 is a display example at the execution of the horse racing game in the embodiment of the betting system according to the present invention;

FIG. 25 is a display example of a second display in the embodiment of the betting system according to the present invention; and

FIG. 26 is a display example of a progressive bonus display unit in the embodiment of the betting system according to the present invention.

### DETAILED DESCRIPTION OF THE EMBODIMENT

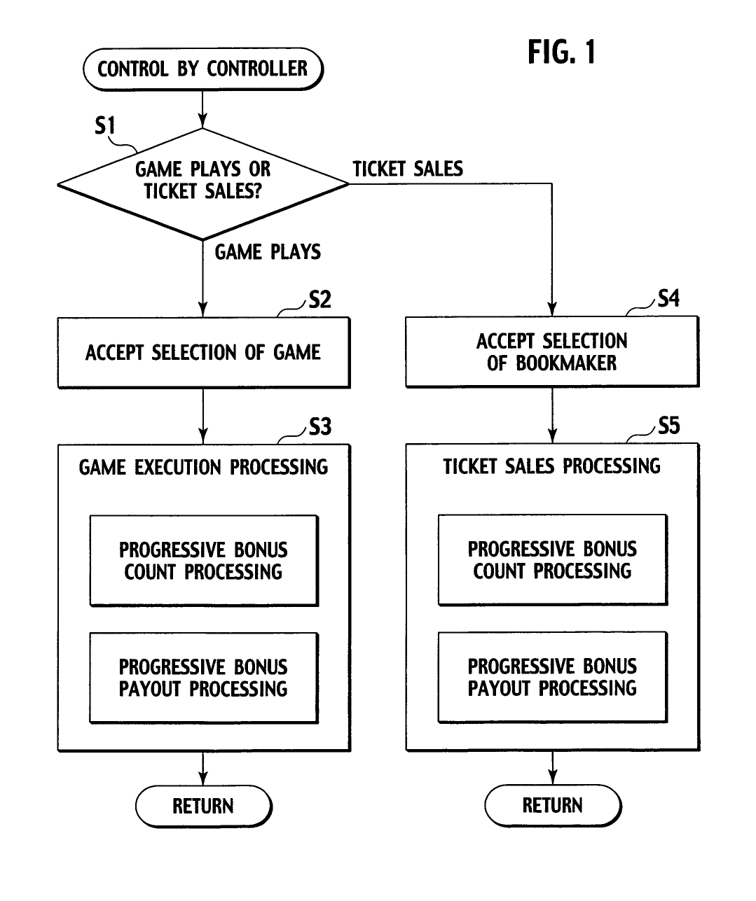

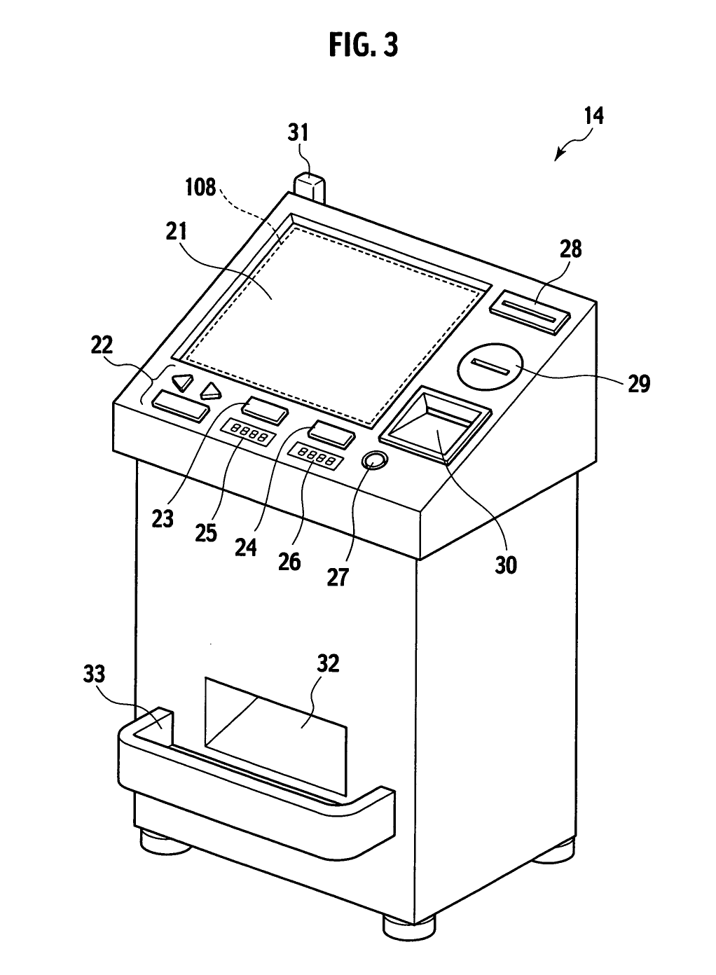

FIG. 1 is a flow-chart showing a process flow of a control executed by a controller of a betting system according to the present invention. FIG. 3 is a perspective view showing a configuration of a terminal 14 employed in the betting system. A schematic process flow of the betting system according to the present invention will be explained with reference to FIGS. 1 and 3 hereinbelow.

First, the controller accepts a selection of ticket sales for betting events or game plays (step S1).

When the “game plays” has been selected (“GAME PLAYS” in step S1), the controller accepts a selection of a game to be played among plural games (step S2). For example, in case where programs of a roulette game and a horse racing game have been downloaded on each terminal 14, a selection of the roulette game or the horse racing game is accepted. When one of the games is selected, the controller executes the selected one of the games (step S3).

At a game execution, the controller accumulates part of a bet amount on a game or part of awarded credits for a winning into a progressive bonus counter as a progressive bonus count value. Then, when a progressive bonus has been awarded in the game execution, all or part of the progressive bonus count value accumulated in the progressive bonus counter is provided as an award.

On the other hand, when the “ticket sales” has been selected (“TICKET SALES” in step S1), the controller displays selectable options of plural bookmakers on the display and then accepts a selection of a bookmaker (step S4). The controller executes ticket sales processing for the betting events for the selected bookmaker (step S5).

In the ticket sales processing, the controller accumulates part of a bet amount obtained in the ticket sales into the progressive bonus counter as the progressive bonus count value. Both of the progressive bonus count value in the game execution and the progressive bonus count value in the ticket sales are accumulated into the progressive counter.

In addition, the controller determines whether or not a progressive bonus is to be awarded for the ticket sales in the ticket sales processing. If a progressive bonus is to be awarded, all or part of the progressive bonus count value accumulated in the progressive counter is provided as an award.

In this manner, with the betting system according to the present invention, the progressive bonus count value accumulated in the game execution and the progressive bonus count value accumulated in the ticket sales for the betting events are accumulated into a single progressive counter. Then, if a progressive bonus is to be awarded in the game execution, or if a progressive bonus is to be awarded in the ticket sales, all or part of the progressive bonus count value is provided as an award. As a result, a player can get an opportunity to obtain more awards.

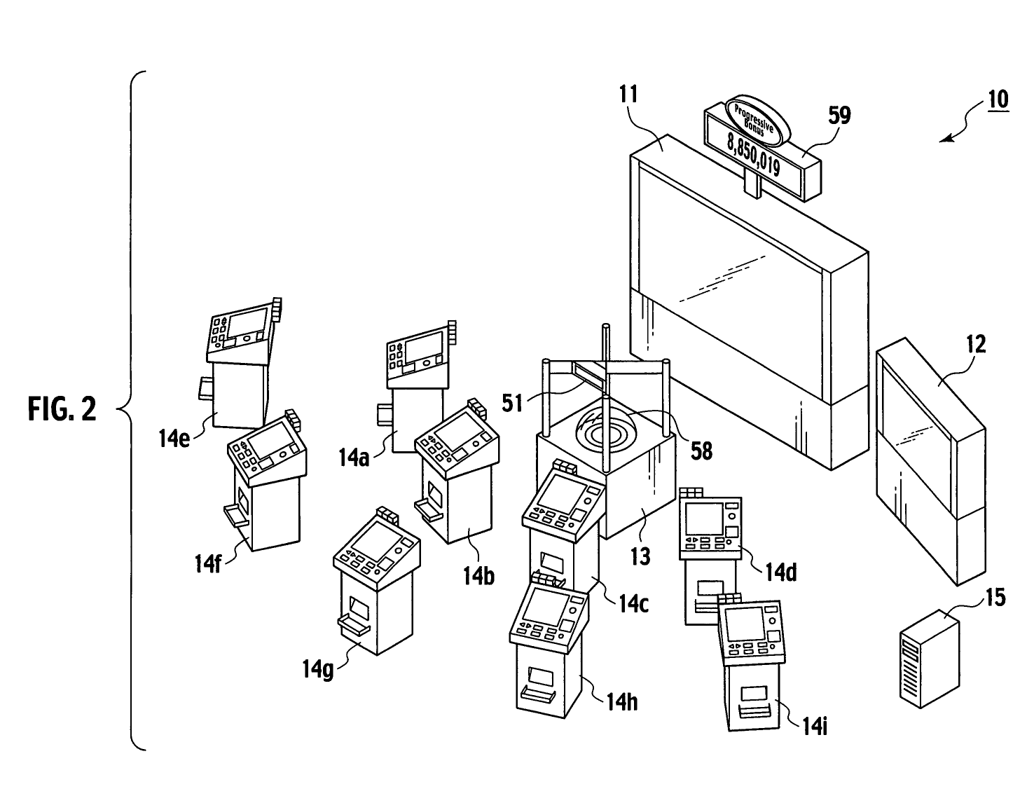

Next, a configuration of the betting system according to an embodiment of the present invention will be explained in detail. FIG. 2 is a view showing general components of the betting system 10 according to the embodiment of the present invention. As shown in FIG. 2, the betting system 10 includes two displays adjacent with each other which are a large first display 11 and a small second display 12, a roulette device 13 on which roulette games are executed, plural (nine, in the figure) terminals 14 (14a to 14i) arranged in front of the first/second display 11/12 and the roulette device 13 in a fan-out arrangement, and a host server 15.

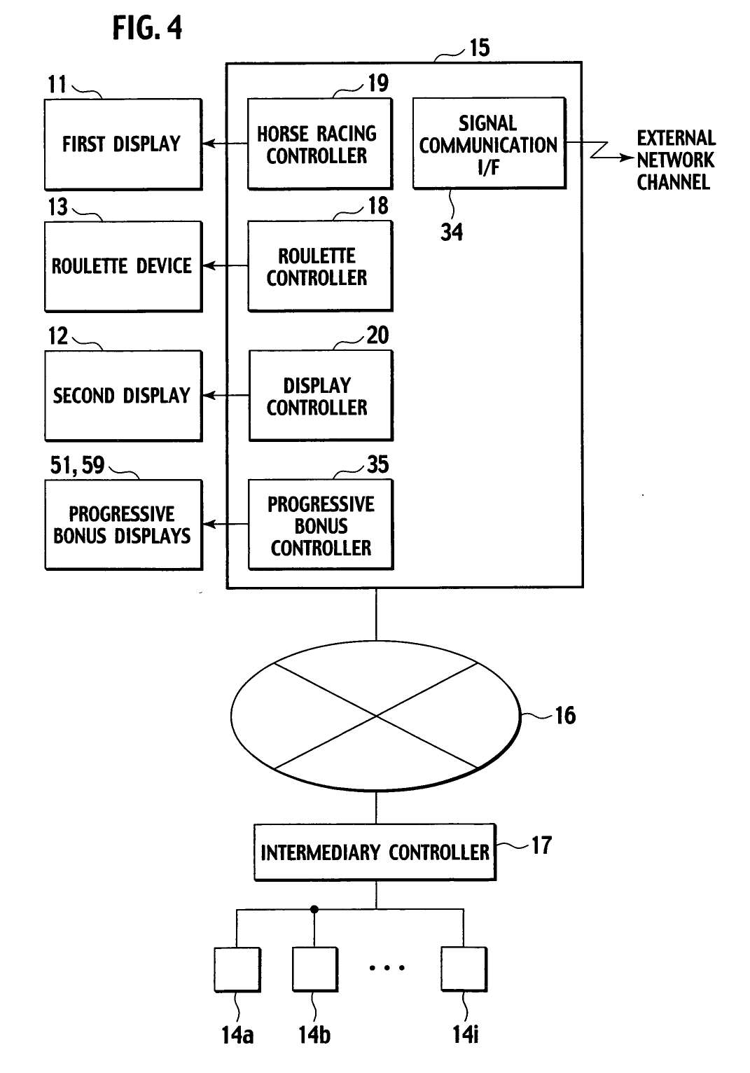

The host server 15 includes a horse racing controller 19 (see FIG. 4) for executing horse racing games, a roulette controller 18 (see FIG. 4) for executing roulette games, and a display controller 20 (see FIG. 4) for displaying information on bookmakers on the second display 12.

A player can participate in a horse racing game executed on the first display 11 or a roulette game executed on the roulette device 13 at each of the terminals 14 (14a to 14i). Furthermore, the player can purchase a betting ticket sold by the bookmaker with reference to the information shown on the second display 12.

FIG. 3 is an appearance view of the terminals 14 (14a to 14i) according to the present embodiment. Here, each of the terminals 14 (14a to 14i) is represented as the terminal 14 in FIG. 3. As shown in FIG. 3, the terminal 14 includes a display 21 for displaying various images, game selection buttons 22 for selecting and determining various selectable options displayed on the display 21, a bet button 23 for betting one credit (one coin), a max-bet button 24 for betting a maximum credit amount (for example, 30 credits), a credit indicator 25 for displaying a current credit amount, a bet indicator 26 for displaying a bet amount, and a payout button 27.

Furthermore, the terminal 14 includes a coin insertion slot 29 into which a coin(s) is inserted, a bill insertion slot 30 into which a bill(s) is inserted, a ticket printer 28 for printing a purchased betting ticket in exchange for a wager such as coins/bills after purchasing a ticket for a betting event sold by a bookmaker, and an indicator lamp 31.

The indicator lamp 31 turns on when a game has been executed at the terminal 14 and then the game brings an award. For example, the indicator lamp 31 turns on when a horse or a combination of horses on which a bet was placed has brought an award in a horse race.

In addition, a cash-out chute 32 for cashing out a coin(s) is provided at a lower part of the terminal 14. Furthermore, an under tray 33 for accumulating the coins had been cashed out is provided beneath the cash-out chute 32.

FIG. 4 is a diagram of connection within a hall in the betting system 10 according to the present embodiment. As shown in FIG. 4, the host server 15 is connected to an intermediary controller 17 via an in-hall channel 16. Furthermore, the intermediary controller 17 is connected to the terminals 14 (14a to 4i). Each of the terminal 14 (14a to 14i) and the host server 15 are operable to send/receive data via the in-hall channel 16.

In addition, the host server 15 includes the horse racing controller 19, the roulette controller 18, the display controller 20, a signal communication I/F 34, and a progressive bonus controller 35. Furthermore, the host server 15 is connected with the first display 11, the second display 12, the roulette device 13, and progressive bonus displays 51 and 59. The signal communication I/F 34 is connected with plural bookmakers via an external network channel and can send/receive information to/from each of the bookmakers.

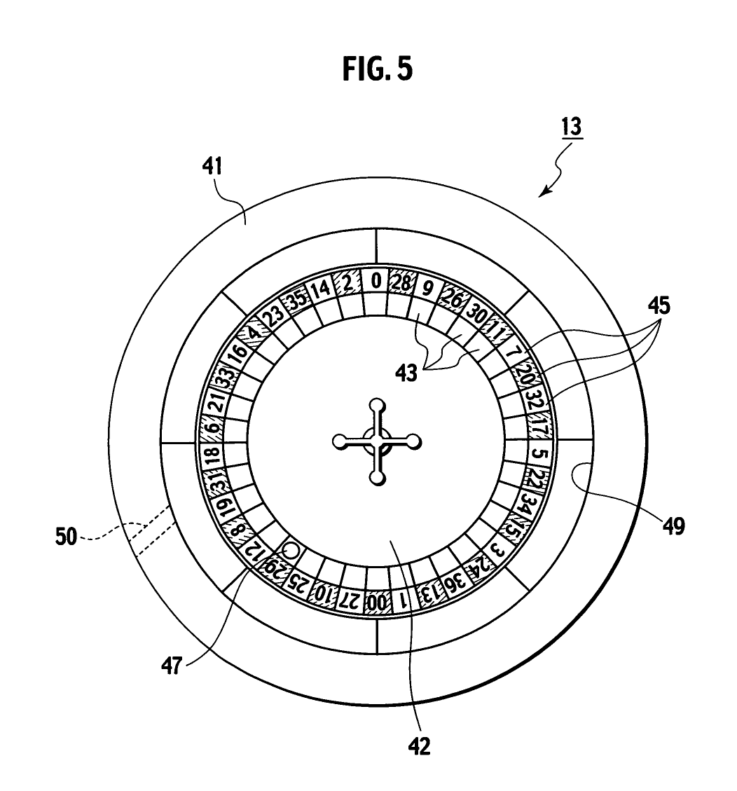

Next, the configuration of the roulette device 13 will be explained in detail. FIG. 5 is an explanatory diagram showing an appearance of the roulette device 13. The roulette device 13 includes, as shown in FIG. 5, a frame 41, a roulette wheel 42 installed rotatably within the frame 41. A lot of depressed number pockets 73 (thirty eight in total in the present embodiment) are provided on an upper surface of the roulette wheel 42. Furthermore, number indicating plates 45, each of which is allocated one of the numbers “0”, “00” and “1” to “36” corresponding to each of the number pockets 43, are provided outside the number pockets 43 on the upper surface of the roulette wheel 42.

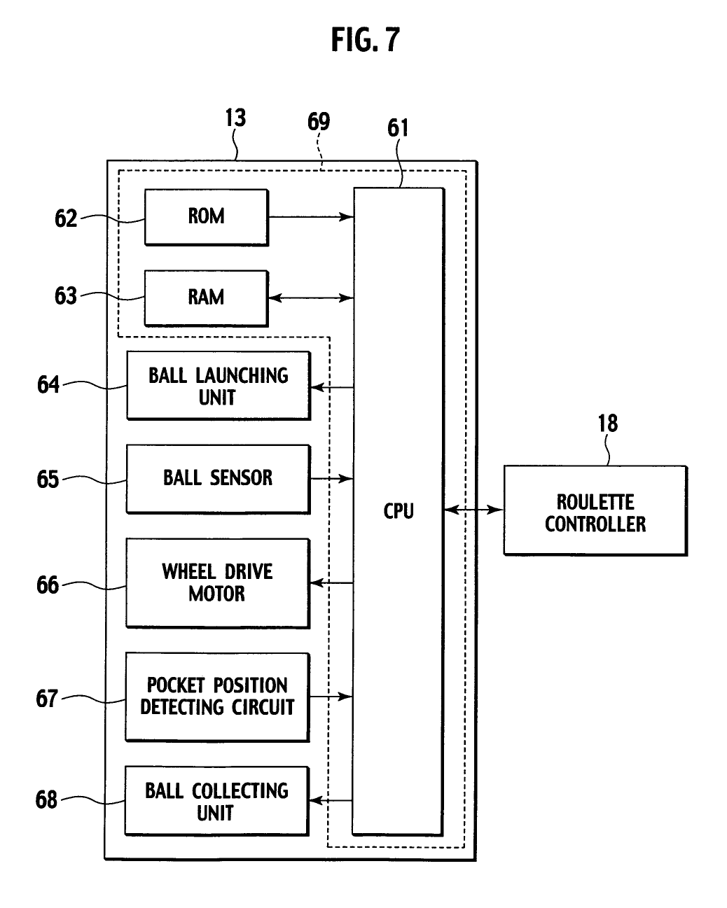

The ball launching port 50 is provided inside the frame 41. The ball launching unit 64 (see FIG. 7) is coupled to the ball launching port 50. A ball 47 is launched onto the roulette wheel 72 from the ball launching port 50 by driving of the ball launching unit 64. In addition, the entire roulette device 13 is covered by a hemispherical transparent acryl cover 58 (see FIG. 2).

A wheel drive motor 66 (see FIG. 7) is provided beneath the roulette wheel 42. The roulette wheel 42 spins by driving of the wheel drive motor 66.

In addition, plural metal plates (not shown in figures) are provided on a back surface of the roulette wheel 42 with spaced apart each other at predetermined intervals. The positions of the number pockets 43 are detected by sensing the metal plates by a proximity sensor included in a pocket position detecting circuit 67 (see FIG. 7).

The frame 41 is moderately inclined to its center. The guide wall 49 is formed around an intermediate circumference of the frame 41. The guide wall 49 guides the launched ball 47 to spin with counter working a centrifugal force of the ball 47. The ball 47, as its velocity slows down, loses its centrifugal force and rolls down on the inclined surface of the frame 41. And then, the ball 47 reaches the spinning roulette wheel 42 and gets across the number plates 45. The ball 47 falls into one of the number pockets 43. As a result, the number of the number plate 45 corresponding to the number pocket 43 into which the ball 47 has fallen, is detected by a ball sensor 65 and determined as a winning number.

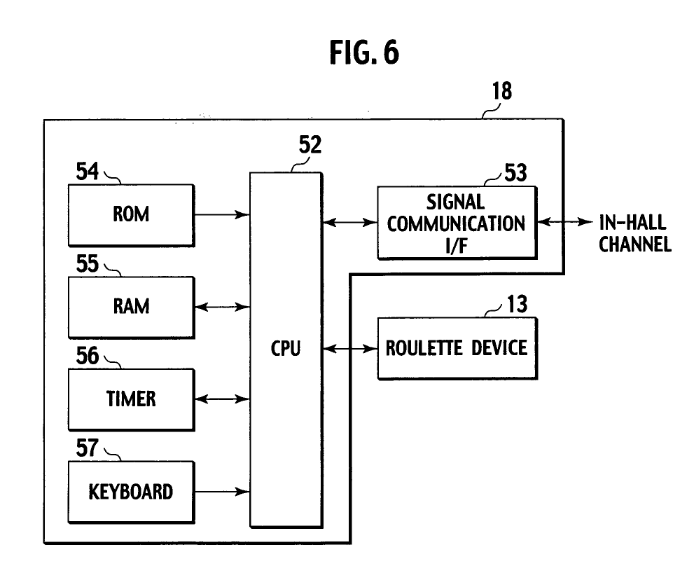

Next, a configuration of the roulette controller 18 provided in the host server 15 will be explained. FIG. 6 is a block diagram showing an internal configuration of the roulette controller 18. As shown in FIG. 6, the roulette controller 18 includes a signal communication I/F 53 which sends/receives data to/from each of the terminals 14 (14a to 14i) via the in-hall channel 16. Furthermore, the roulette controller 18 is connected with the roulette device 13.

The roulette controller 18 includes a CPU 52 for controlling the entire roulette controller 18 totally, a ROM 54 for storing system programs, a RAM 55 for temporarily storing data, a timer 56, and a keyboard 57.

The CPU 52 executes various processings based on input signals supplied from each of the terminals 14 (14a to 14i) and data and programs stored in the ROM 54 and the RAM 55. The CPU 52 initiatively controls the terminals 14 (14a to 14i) connected to the intermediary controller 17 by sending command signals to the intermediary controller 17 based on the results of the processings. In addition, the CPU 52 controls launching of the ball 47 or spinning of the roulette wheel 42 by sending control signals to the roulette device 13.

The ROM 54 is composed of semiconductor memories, for example. The ROM 54 stores programs for executing basic functionalities of the roulette device 13, programs for setting/managing maintenance notifying timings and maintenance conditions, odds (an payout credit amount per one coin) for the roulette game, and programs for initiatively controlling the terminals 14 (14a to 14i).

The RAM 55 temporarily stores bet credit information supplied from each of the terminals 14 (14a to 14i), a winning number had been detected by the pocket position detecting circuit 67 (see FIG. 7) in the roulette device 13, and result data of the processings executed by the CPU 52.

Furthermore, the timer 56 for counting time is connected to the CPU 52. Time information of the timer 56 is sent to the CPU 52. The CPU 52 controls after-mentioned spinning of the roulette wheel 42 and launching of the ball 47 based on the time information of the timer 56. In addition, the CPU 52 produces illuminating effects by controlling illumination of LEDs (not shown) provided around the roulette device 13 or the like.

FIG. 7 is a block diagram showing an internal configuration of the roulette device 13 according to the present embodiment. As shown in FIG. 7, the roulette device 13 includes a control unit 69, the pocket position detecting circuit 67, the ball launching unit 64, a ball sensor 65, the wheel drive motor 66, and a ball collecting unit 68.

The control unit 69 includes a CPU 61, a ROM 62 and a RAM 63. The CPU 61 controls launching of the ball 47 and spinning of the roulette wheel 42 based on control signals supplied from the roulette controller 18 and data and program stored in the ROM 62 and the RAM 63.

The ball launching unit 64 is a device for launching the ball 47 onto the roulette wheel 42 from the ball launching port 50. The ball launching unit 64 launches the ball 47 onto the roulette wheel 42 at an initial velocity which has been set based on the control data stored in ROM 62. The ball sensor 65 detects which one of the number pockets 43 the ball 47 has fallen into. The wheel drive motor 66 spins the roulette wheel 42. Driving of the wheel drive motor 66 is terminated when a motor drive time period which has been set in the control data has elapsed since the start of driving. The ball collecting unit 68 is a device for collecting the ball 47 on the roulette wheel 42 after a game has ended.

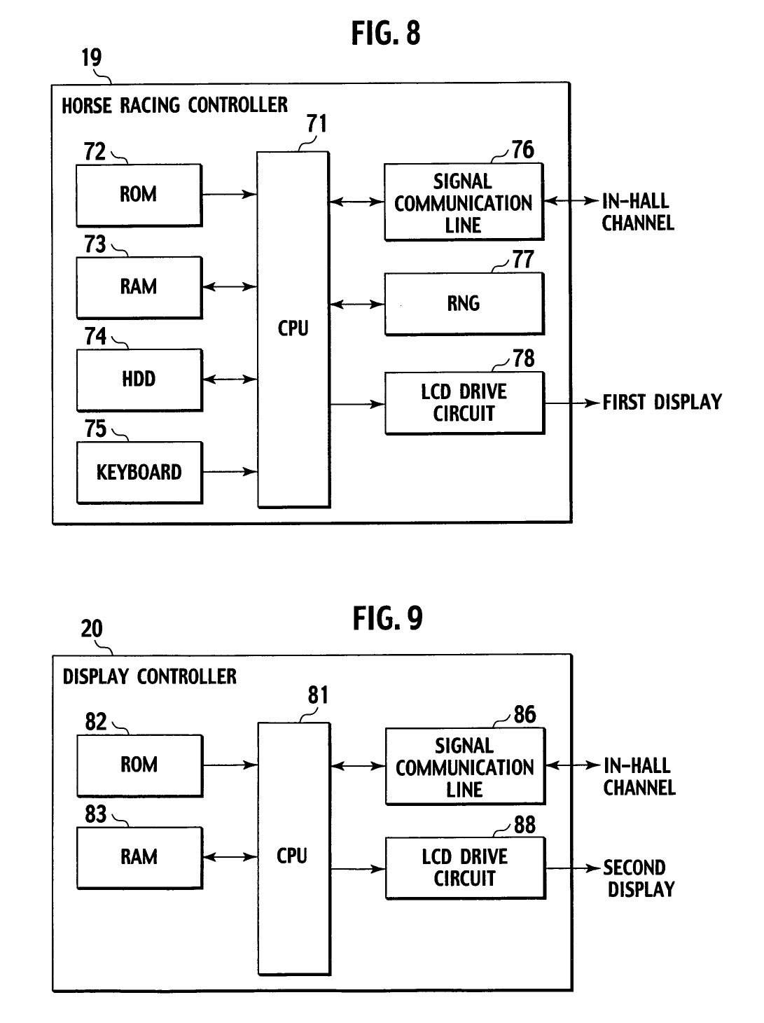

FIG. 8 is a block diagram showing an internal configuration of the horse racing controller 19. The horse racing controller 19 controls the horse racing game executed on the first display 11. As shown in FIG. 8, the horse racing controller 19 includes a CPU 71 for controlling a horse racing game totally, a ROM 72, a RAM 73, a hard diskdrive 74 for storing horse racing game programs, a keyboard 75 for accepting administrator's input operation, a signal communication I/F 76 for communicating via the in-hall channel 16, a random number generator (RNG) 77 for generating various random numbers relating to a horse racing game execution, and a liquid crystal display (LCD) drive circuit 78 for controlling screen-displays on the first display 11.

FIG. 9 is a block diagram showing an internal configuration of the display controller 20. The display controller 20 controls screen-displays relating to information on betting events of bookmakers. As shown in FIG. 9, the display controller 20 includes a CPU 81 for controlling screen-displays on the second display 12 totally, a ROM 82, a RAM 83, a signal communication I/F 86, and an LCD drive circuit 88 for controlling screen-displays on the second display 12.

FIG. 25 is an exemplary screen-display on the second display 12. In this exemplary screen-display, information on planned betting events is displayed. Players can utilize this screen-display for ticket-purchasing of the betting events.

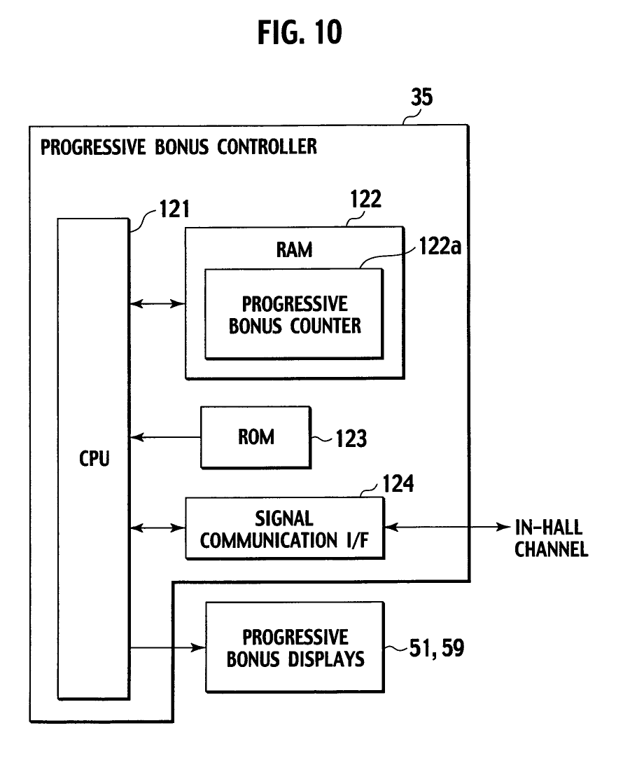

FIG. 10 is a block diagram showing an internal configuration of the progressive bonus controller 35. As shown in FIG. 10, the progressive bonus controller 35 includes a CPU 121 for controlling the progressive bonus controller 35 totally, a RAM 122, a ROM 123, and a signal communication I/F 124.

The signal communication I/F 124 sends/receives signals to/from each of the terminals 14 (14a to 14i) via the in-hall channel 16. The RAM 122 has a functionality of reading/writing various data. The RAM 122 implements a progressive bonus counter 122a. The progressive bonus counter 122a accumulates progressive count value generated in horse racing games and roulette games at each of the terminals 14 (14a to 14i), and the progressive count value generated in ticket sales for the betting events.

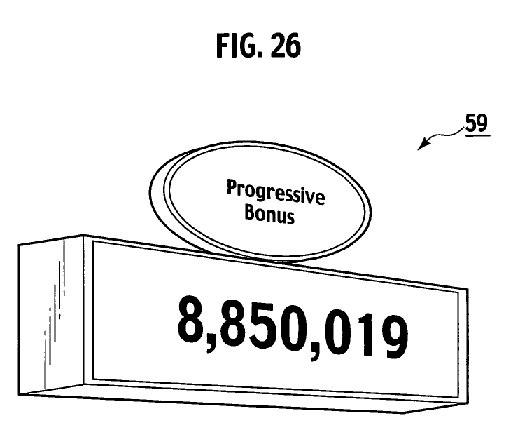

In addition, the progressive bonus controller 35 controls displaying the progressive bonus count value accumulated in the progressive bonus counter 122a on the progressive bonus display 51 provided above the roulette device 13 and on the progressive bonus display 59 provided on the top of the first display 11. FIG. 26 is an exemplary presentation of the progressive bonus display 59 provided on the top of the first display 11. The value displayed thereon changes continually.

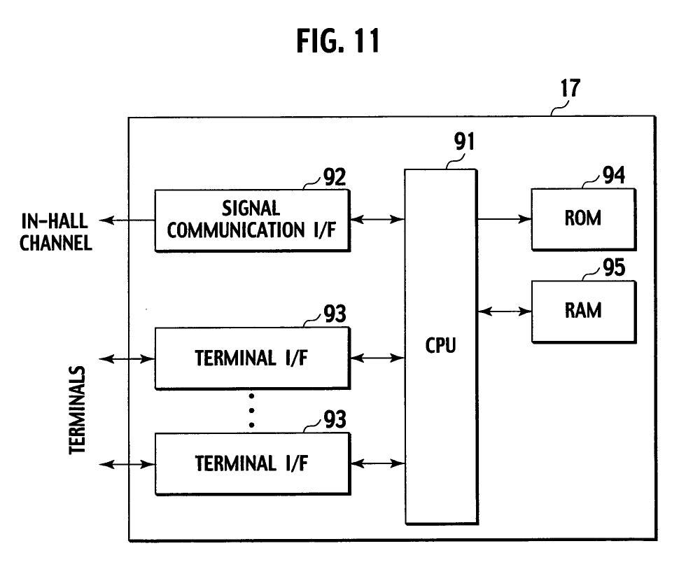

FIG. 11 is a block diagram showing an internal configuration of the intermediary controller 17. As shown in FIG. 11, the intermediary controller 17 includes a CPU 91 for executing total control, a signal communication I/F 92 for communicating via the in-hall channel 16, terminal I/Fs 93 for communicating with each of the terminals 14 (14a to 14i), a ROM 94, and a RAM 95. The CPU 91 controls setting of bet acceptance period in roulette games executed by the roulette controller 18 and horse racing games executed by the horse racing controller 19.

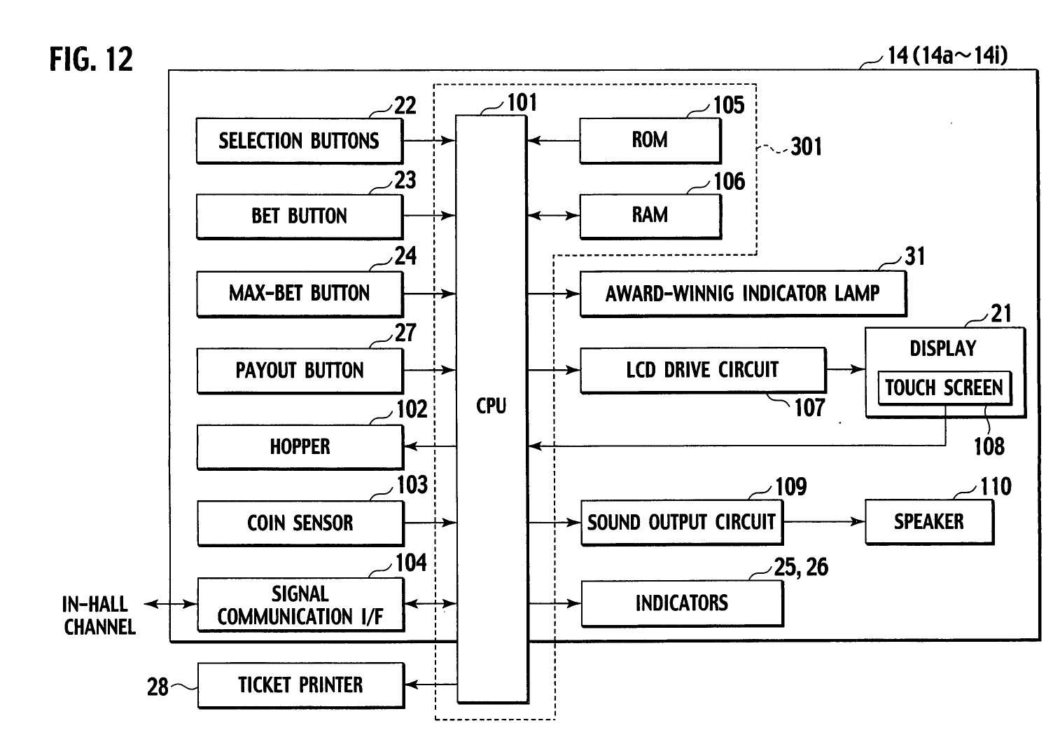

FIG. 12 is a block diagram showing an internal configuration of the terminal 14 (14a to 14i) according to the present embodiment. Note that, since the nine terminals 14 (14a to 14i) have an identical configuration basically, the terminal 14 will be explained hereinbelow.

As shown in FIG. 12, the terminal 14 includes a controller 301 having a CPU 101, a ROM 105, and a RAM 106. The ROM 105 is composed of semiconductor memories or the like, for example. The ROM 105 stores programs for executing basic functionality of the terminal 14, various other programs necessary to control the terminal 14, data tables and so on. In addition, the RAM 106 is a memory for temporarily storing various data calculated by the CPU 101, a current credit amount owned by a player (stored in the terminal 14) and player's betting status.

In addition, the selection buttons 22 for selecting among various selectable options displayed on the display 21, the bet button 23 for betting one credit, the max-bet button 24 for betting a maximum credit amount and the payout button 27 for paying out credited coins, are connected to the CPU 101. Furthermore, both of the credit indicator 25 and the bet indicator 26 are connected to the CPU 101. In addition, a hopper 102 and a coin sensor 103 are connected to the CPU 101.

The CPU 101 controls executions of various corresponding operations based on operation signals had been output due to pressing down the buttons 22, 23, 24 and 27. Specifically, the CPU 101 executes various processings in response to player's input operations based on input signals supplied from the buttons 22, 23, 24 and 27 and data and programs stored in the ROM 105 and the RAM 106. And then the CPU 101 sends the results to the host server 15 via the intermediary controller 17 and the in-hall channel 16.

The coin sensor 103 detects coins inserted into the coin insertion slot 29 to count the number of inserted coins and outputs the counting result data to the CPU 101. The CPU 101 increases the credit amount which is owned by a player and stored in the RAM 106 based on the counting result data.

The hopper 102 cashes out a predetermined number of coins from the cash-out chute 32 (see FIG. 3) based on a command signal supplied from the CPU 101.

In addition, the award-winning indicator lamp 31, an LCD drive circuit 107 and a sound output circuit 109 are connected to the CPU 101.

The LCD drive circuit 107 controls screen images displayed on the display 21. The LCD drive circuit 107 includes a program ROM, an image ROM, an image control CPU, a work RAM, a VDP (video display processor) and a video RAM.

The program ROM stores image control programs relating to screen-displays on the display 21 and various selection tables. The image ROM stores, for example, dot data for forming images to be displayed on the display 21. The image control CPU determines, images to be displayed on the display 21 among the dot data preliminarily stored in the image ROM according to the image control programs preliminarily stored in the program ROM based on parameters had been set by the CPU 101.

The work RAM is configured as a temporary memory during execution of the image control programs by the image control CPU. The VDP forms screen images according to display contents determined by the image control CPU and outputs them to the display 21. Note that the video RAM is also configured as a temporary memory for forming the screen images by the VDP.

In addition, a touch screen 108, which accepts player's touch operations and outputs input signals to the CPU 101, is provided on the display 21. The touch screen 108 is used with the above-mentioned selection buttons 22 for selecting operations in game plays or in ticket sales for betting events.

The sound output circuit 109 controls producing various sound effects and is connected with a speaker 110.

Next, various screen image examples to be displayed on the screen of the display 21 provided on each of the terminals 14 will be explained.

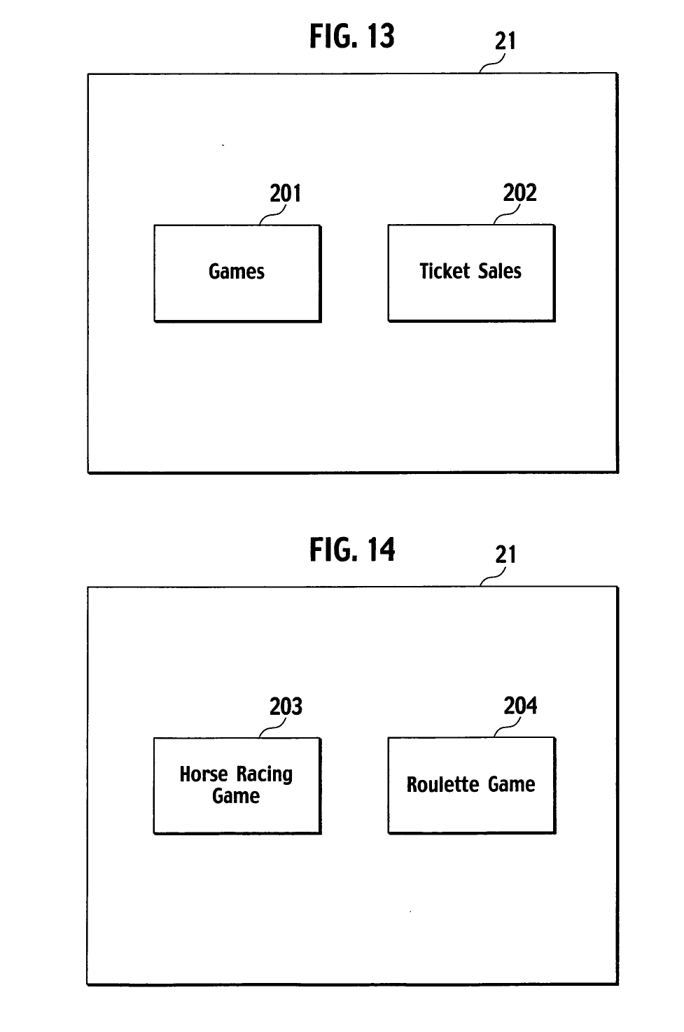

FIG. 13 shows an initial screen display. A screen image for selecting game plays or ticket sales is displayed on the display 21. Specifically, a “Games” image 201 and a “Ticket Sales” image 202 are displayed as selectable options and player's selection is to be accepted. The selection can be made via the selection buttons 22 or the touch screen 108.

FIG. 14 is a screen display example after the “Games” image 201 has been selected on the screen display shown in FIG. 13. A “Horse Racing Game” image 203 and a “Roulette Game” image 204 are displayed as selectable game options. The player can participate in the desired game by selecting one of the selectable options.

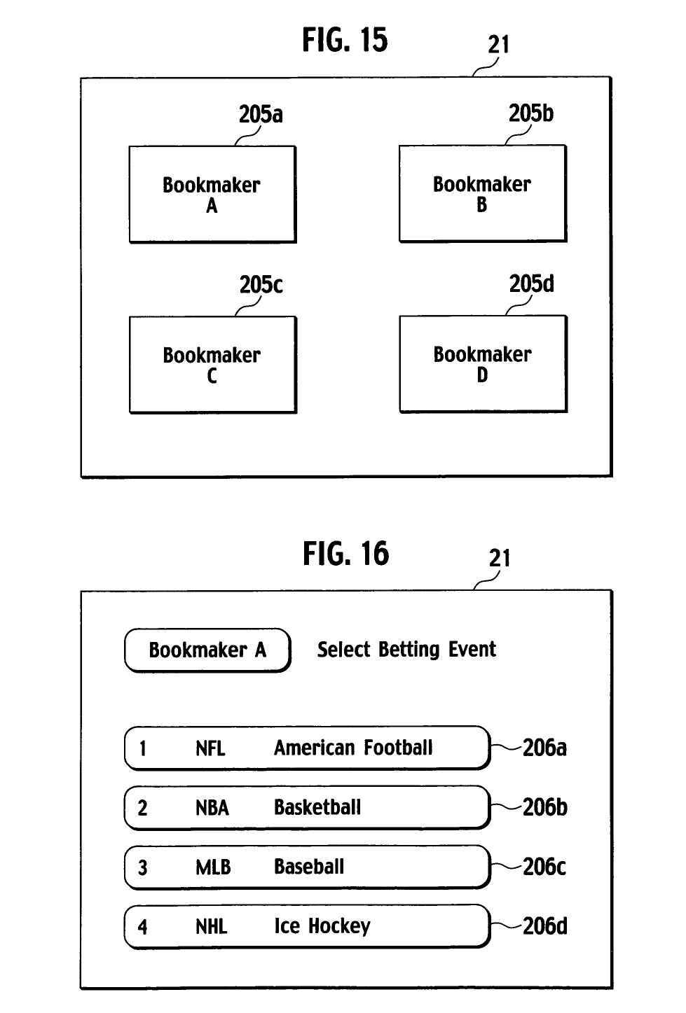

FIG. 15 is a screen display example after the “Ticket Sales” image 202 is selected on the display screen shown in FIG. 13. Four “Bookmaker” images 205a, 204b, 205c and 205d for selling tickets of the betting events are displayed as selectable options.

FIG. 16 is a screen display example after the “Bookmaker A” image 205a is selected on the display screen shown in FIG. 15. An “NFL American Football” image 206a, an “NBA Basketball” image 206b, an “MLB Baseball” image 206c and an “NHL Ice Hockey” image 206d are displayed as selectable options for the betting events.

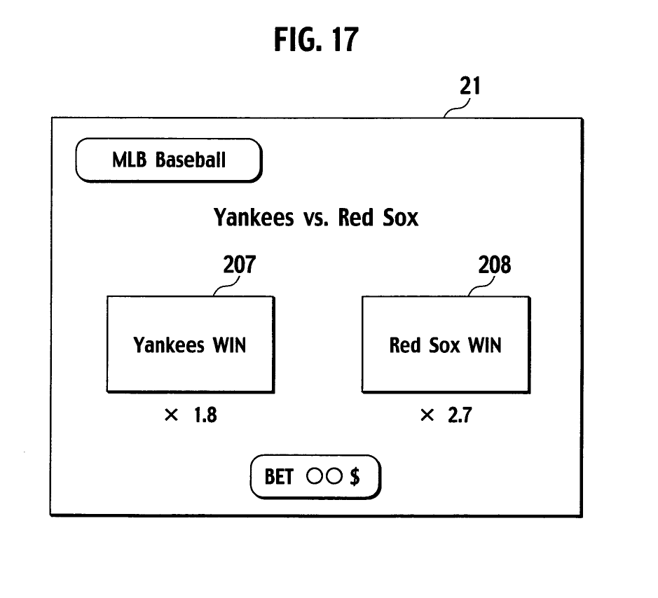

FIG. 17 is a screen display example after the “MLB Baseball” is selected on the display screen shown in FIG. 16. A ticket sales screen for predicting the result of the game between “Yankees” and “Red Sox” is displayed. Specifically, a “Yankees WIN” image 207 for selecting a win of “Yankees” and a “Red Sox WIN” image 208 for selecting a win of “Red Sox” are displayed. In addition, it is displayed that odds for a win of “Yankees” is x1.8, and odds for a win of “Red Sox” is x2.7.

Next, operations of the betting system 10 according to the present embodiment configured as above will be explained. FIG. 1 is a flow-chart showing a process flow by the controller 301 of the betting system 10. First, the controller 301 displays the “Games” image 201 and the “Ticket Sales” image 202 on the display 21 as shown in FIG. 13, and accepts a player's selection of the game plays or the ticket sales (step S1). This selecting operation is done by the operation buttons 22 or the touch screen 108 shown in FIG. 3.

If the “Games” image 201 is selected (“GAME PLAYS” in step S1), the controller 301 displays the “Horse Racing Game” image 203 and the “Roulette Game” image 204 on the display 21 as shown in FIG. 14, and accepts a player's selection of the horse racing game or the roulette game (step S2).

The controller 301 subsequently executes the selected game (step S3). The game execution processing will be described later.

On the other hand, if the “Ticket Sales” image 202 is selected on the screen display shown in FIG. 13 (“TICKET SALES” in step S1), the controller 301 displays the selectable options of the bookmakers selling tickets on the display 21. Specifically, as shown in FIG. 15, the controller 301 displays the “Bookmaker A” image 205a, the “Bookmaker B” image 205b, the “Bookmaker C” image 205c and the “Bookmaker D” image 205d on the display 21, and accepts a player's selection of one of the bookmakers (step S4).

Subsequently, the controller 301 executes the ticket sales processing for the selected bookmaker (step S5). The ticket sales processing will be described later.

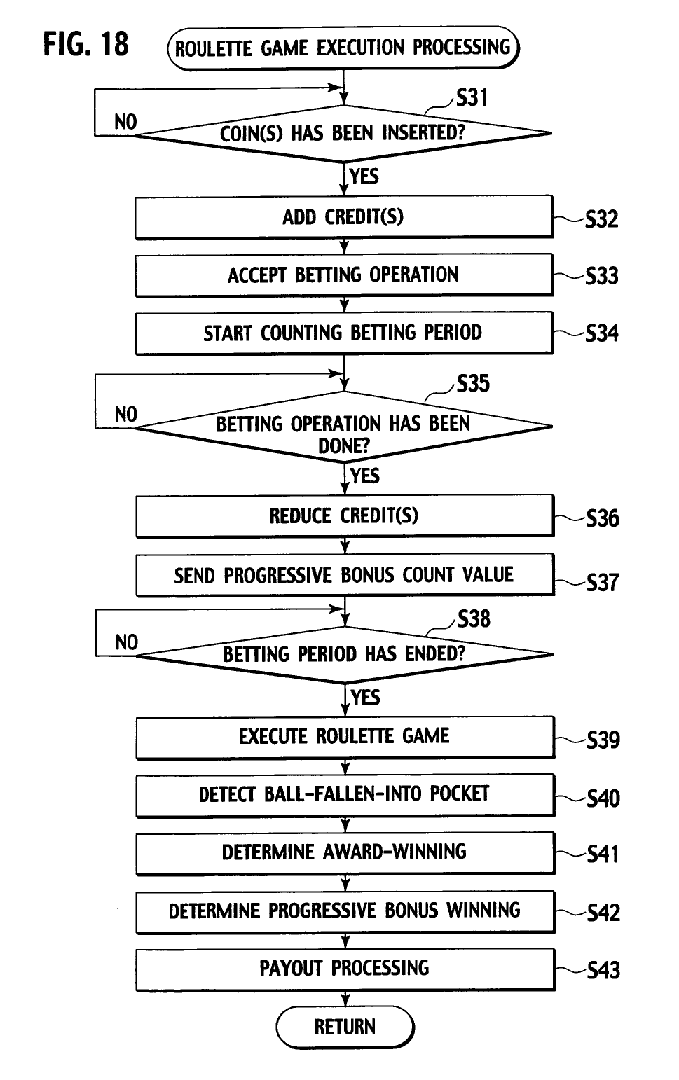

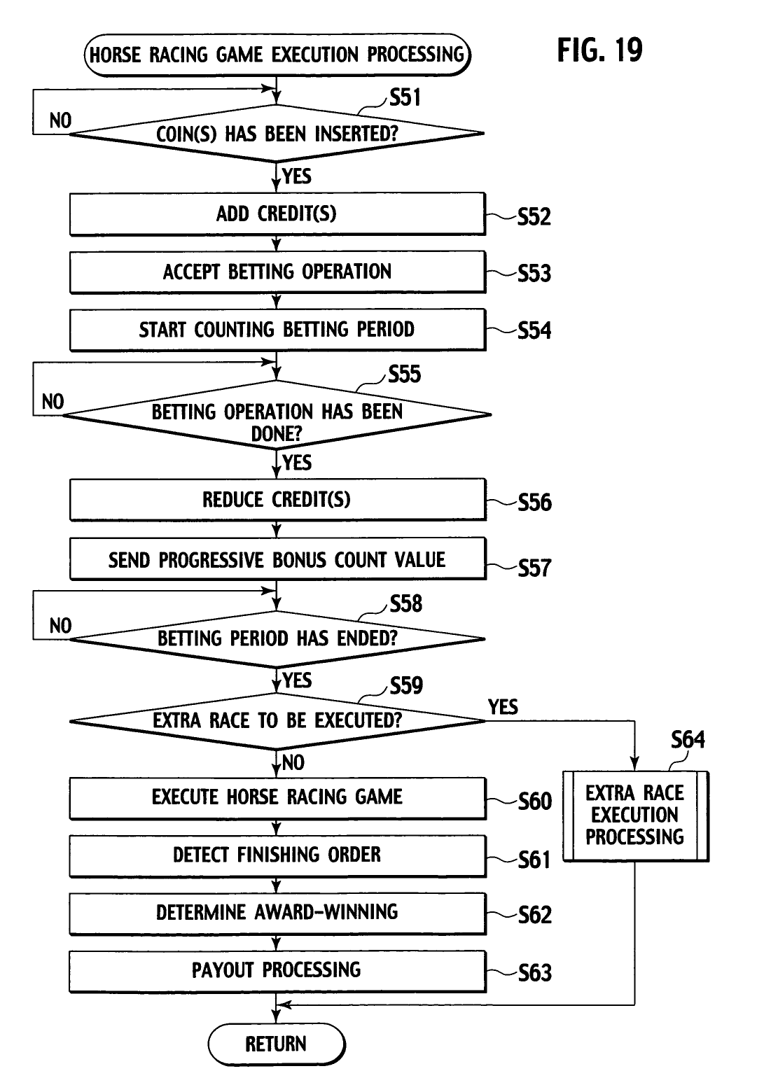

Next, the game execution processing of step S3 in FIG. 1 will be explained with reference to flow-charts shown in FIGS. 18 and 19. FIG. 18 is a flow-chart showing the roulette game execution processing.

The controller 301 in the terminal 14 determines whether or not a coin(s) has been inserted into the coin insertion slot 29 and whether or not a bill(s) is inserted into the bill insertion slot 30 (step S31). If it is detected that a coin(s) or a bill (s) has been inserted, the controller 301 accumulates a credit amount corresponding to the inserted coin(s) or bill(s) (step S32).

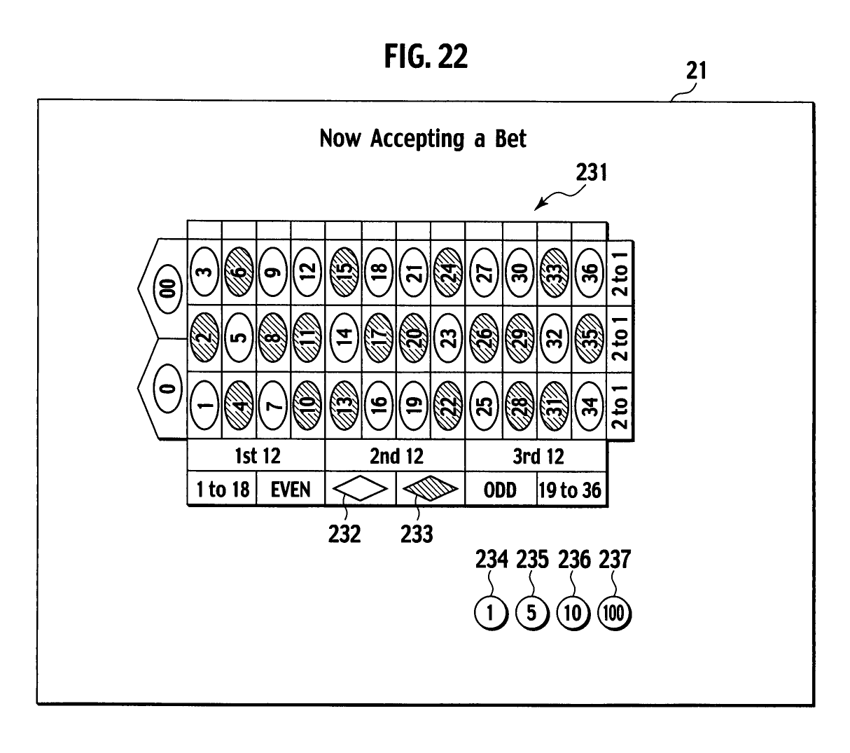

The controller 301 accepts a player's betting operation (step S33). FIG. 22 is an explanatory image showing an example of a bet accepting screen image 231 displayed on the display 21. As shown in FIG. 22, total 38 numbers of “0”, “00” and “1” to “36” are displayed. A player can achieve a betting operation by touching these numbers or various selection areas and the touching bet amount areas 234, 235, 236 and 237. A “1st 12” area for betting on “1 to 12”, a “2nd 12” area for betting on “13 to 24”, a “3rd 12” area for betting on “25 to 36”, a red selection area 232 for betting on red numbers, a black selection area 233 for betting on black numbers and so on are displayed as selection areas.

Next, the controller 301 starts counting betting period by the timer implemented in the RAM 106 (step S34). The betting period is set to fifteen seconds, for example. The controller 301 determines whether or not a betting operation has been done by a player (step S35). If a betting operation has been done, a credit amount corresponding to the betting operation is subtracted (step S36).

In addition, the controller 301 sets some (for example, one for twenty credits) of the credit amount had been placed as the progressive bonus count value. The controller 301 sends data of the progressive bonus count value to the host server 15 via the intermediary controller 17 and the in-hall channel 16 shown in FIG. 4 (step S37). The progressive bonus count value is accumulated into the progressive bonus counter 122a in the progressive bonus controller 35 shown in FIG. 10.

The controller 301 determines whether or not the betting period has ended (step S38). If the betting period has ended (YES in step S38), the controller 301 executes a roulette game (step S39). In the roulette game, the ball 47 is launched onto the roulette wheel 42 from the ball launching port 50 shown in FIG. 5 and a winning number is determined according to the number pocket 43 in which the ball 47 stays at the time when the roulette 42 has stopped spinning.

The controller 301 determines the number pocket 43 into which the ball 47 has fallen (step S40). The controller 301 compares the winning number with the number on which the player has placed a bet to determine whether or not an award is to be awarded (step S41).

Furthermore, the controller 301 determines whether or not a progressive bonus is to be awarded (step S42). For example, a progressive bonus may be allocated to the number pocket “00” shown in FIG. 5. If the ball 47 has fallen into the number pocket “00”, it is determined that a progressive bonus is to be awarded.

Subsequently, the controller 301 executes payout processing for an award(s) (step S43). In the payout processing, if it is determined that an award is to be awarded in the processing of step S41, coins or credits are provided according to the odds. If a progressive bonus is to be awarded, coins or credits corresponding to all or part of the progressive count value accumulated in the progressive counter 122a are provided. In this manner, the roulette game is executed.

Here, a coin amount or a credit amount to be awarded for the progressive bonus may be varied according to a bet amount on a roulette game. In other words, the more bet amount has been placed, the more progressive bonus can be awarded.

Additionally, in the above-explained roulette game, the progressive bonus count value is determined according to the bet amount which has been placed on the roulette game. Specifically, one credit is accumulated as the progressive bonus count value into the progressive bonus counter 122a when a twenty-credit bet has been placed. Alternatively, part of a payout amount to be awarded when a game has brought an award may be accumulated as the progressive bonus count value into the progressive bonus counter 122a. In this case, the progressive bonus count value will not be accumulated according to a bet amount on a roulette game. Part of a credit amount to be awarded will be accumulated as the progressive bonus count value into the progressive bonus counter 122a when a game has brought an award.

Next, the horse racing game execution processing will be explained with reference to a flow-chart shown in FIG. 19. The controller 301 in the terminal 14 determines whether or not a coin(s) has been inserted into the coin insertion slot 29 and whether or not a bill(s) is inserted into the bill insertion slot 30 (step S51). If it is detected that a coin(s) or a bill(s) has been inserted, the controller 301 accumulates a credit amount corresponding to the inserted coin(s) or bill(s) (step S52).

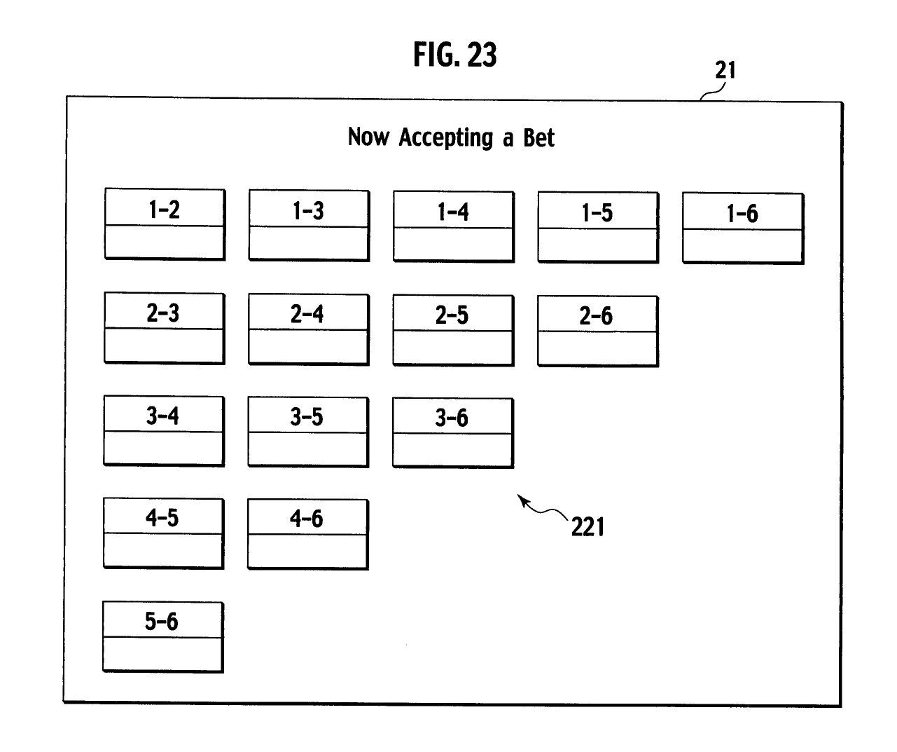

The controller 301 accepts a player's betting operation (step S53). FIG. 23 is an explanatory image showing an example of a bet accepting screen image 231 displayed on the display 21. As shown in FIG. 23, a screen image for accepting expected racehorses to finish first and second is displayed on the display 21. A player can bet credits on a desired finishing order by touching respective images.

Next, the controller 301 starts counting betting period by the timer implemented in the RAM 106 (step S54). The betting period is set to thirty seconds, for example. The controller 301 determines whether or not a betting operation has been done by a player (step S55). If a betting operation has been done, a credit amount corresponding to the betting operation is subtracted (step S56).

In addition, the controller 301 sets some (for example, one for twenty credits) of the credit amount had been placed as the progressive bonus count value. The controller 301 sends data of the progressive bonus count value to the host server 15 via the intermediary controller 17 and the in-hall channel 16 shown in FIG. 4 (step S57). The progressive bonus count value is accumulated into the progressive bonus counter 122a in the progressive bonus controller 35 shown in FIG. 10.

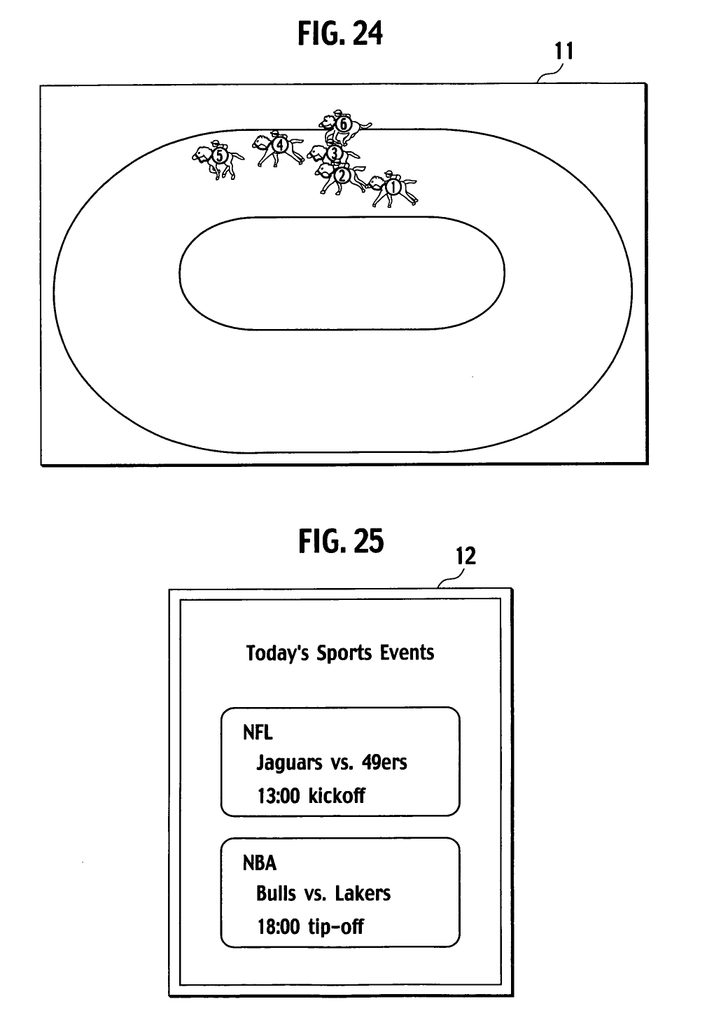

The controller 301 determines whether or not the betting period has ended (step S58). If the betting period has ended (YES in step S58), the controller 301 determines whether or not an extra race is to be executed with a preset probability (step S59). If it is determined that the extra game is not to be executed (NO in step S59), the controller 301 executes a horse racing game (step S60). In the horse racing game, a race with six race horses is displayed on the first display 11 as shown in FIG. 24, a winning number is determined according to the numbers of the racehorses which has finished first and second.

The controller 301 determines finishing combination according to the racehorses which has finished first and second (step S61). The controller 301 compares the finishing combination with the finishing combination on which the player has placed a bet to determine whether or not an award is to be awarded (step S62).

Subsequently, the controller 301 executes payout processing for an award (step S63). In the payout processing, if it is determined that an award is to be awarded in the processing of step S62, coins or credits are provided according to the odds.

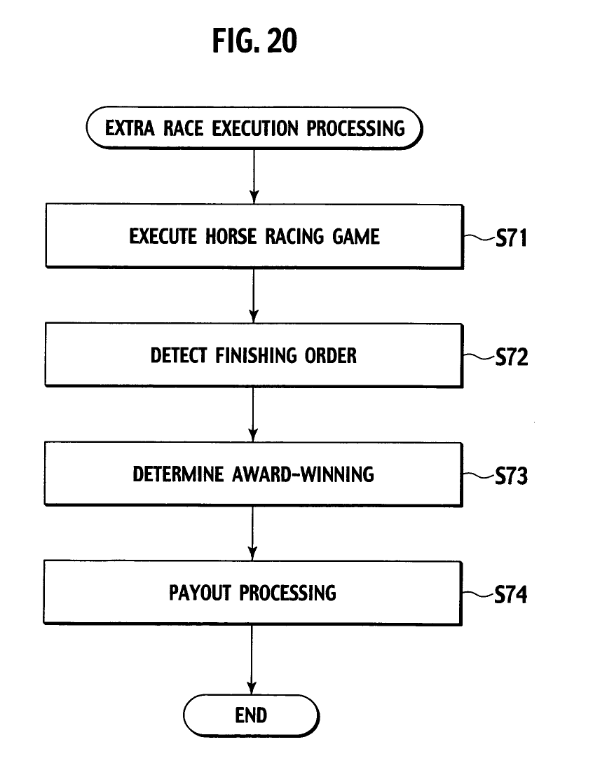

On the other hand, if it is determined that the extra game is to be executed (YES in step S59), extra race execution processing is executed (step S64). FIG. 20 is a flow-chart of the extra race execution processing.

First, the controller 301 executes a horse racing game (step S71). In the horse racing game, a race with six race horses is displayed on the first display 11 as shown in FIG. 24. Then the controller 301 determines a finishing combination as the game result, i.e. the first and second finishing horses (step S72). The controller 301 compares the finishing combination determined as the game result with the finishing combination on which the player has placed a bet to determine whether or not an award is to be awarded (step S73). If it is determined that an award is to be awarded, the controller 301 executes payout processing for the progressive bonus (step S74) If a progressive bonus is to be awarded, coins or credits corresponding to all or part of the progressive count value accumulated in the progressive counter 122a are provided. In this manner, the horse racing game is executed.

Here, a coin amount or a credit amount to be awarded for the progressive bonus may be varied according to a bet amount on a horse racing game. In other words, the more bet amount has been placed, the more progressive bonus can be awarded.

Additionally, in the above-explained horse racing game, the progressive bonus count value is determined according to the bet amount which has been placed on the horse racing game. Specifically, one credit is accumulated as the progressive bonus count value into the progressive bonus counter 122a when a twenty-credit bet has been placed. Alternatively, part of a payout amount to be awarded when a game has brought an award may be accumulated as the progressive bonus count value into the progressive bonus counter 122a. In this case, the progressive bonus count value will not generated based on a bet on a horse racing game. Part of a credit amount to be awarded will be accumulated as the progressive bonus count value into the progressive bonus counter 122a when a game has brought an award.

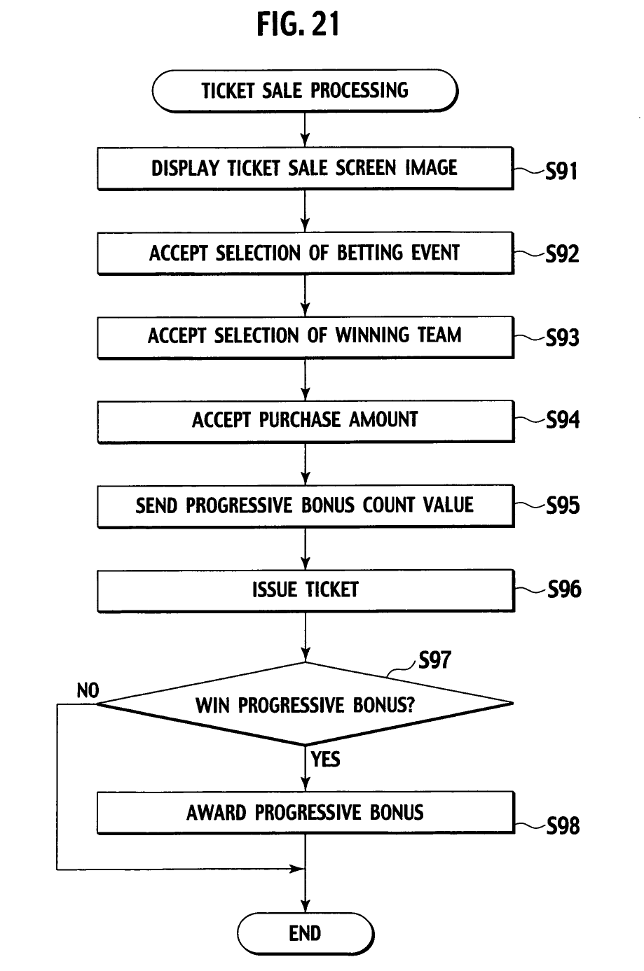

Next, the ticket sales processing will be explained with reference to a flow-chart shown in FIG. 21. First, the controller 301 displays the ticket sales screen image on the display 21 (step S91). In case where there are plural bookmakers, the screen image shown in FIG. 15 is displayed for a player to select one of the bookmakers. When one of the bookmakers is selected by the player, the screen image of selectable options for betting events will be displayed. As shown in FIG. 16, selectable option images 206a to 206d of betting events are displayed, for example.

The controller 301 accepts the selection of a desired betting event (step S92). Specifically, operations into the operation buttons 22 or the touch screen 108 shown in FIG. 3 are permitted and input operations into the operation buttons 22 or the touch screen 108 are accepted.

For example, if the “MLB Baseball” image 206c is selected among the selectable option images 206a to 206d for the betting events shown in FIG. 16, the controller 301 displays selectable option images for expected winning teams on the display 21 as shown in FIG. 17. Specifically, the “Yankees WIN” image 207 and the “Red Sox WIN” image 208 are displayed and a bet on a expected winning team is accepted (step S93). Subsequently, the controller 301 accepts a purchased amount based on an insertion of bills into the bill insertion slot 30 or an insertion of coins into the coin insertion slot 29 (step S94).

In addition, the controller 301 sets some (for example, one for twenty credits) of the purchased amount as the progressive bonus count value. The controller 301 sends data of the progressive bonus count value to the host server 15 via the intermediary controller 17 and the in-hall channel 16 shown in FIG. 4 (step S95). The progressive bonus count value is accumulated into the progressive bonus counter 122a in the progressive bonus controller 35 shown in FIG. 10.

The controller 301 determines whether or not the betting period has ended (step S38). If the betting period has ended (YES in step S38), the controller 301 executes a roulette game (step S39). In the roulette game, the ball 47 is launched onto the roulette wheel 42 from the ball launching port 50 shown in FIG. 5 and a winning number is determined according to the number pocket 43 in which the ball 47 stays at the time when the roulette 42 has stopped spinning.

Next, the controller 301 prints out a ticket purchased by the player by the thicket printer 28 (step S96). Here, the controller 301 determines whether or not an award of the progressive bonus is to be awarded with a preset probability (step S97). If an award of the progressive bonus is to be awarded (YES in step S97), all or part of the progressive count value accumulated in the progressive counter 122a is provided. In this manner, the ticket sales processing is executed.

Here, a coin amount or a credit amount to be awarded for the progressive bonus may be varied according to a purchased amount of a ticket. In other words, the more the purchased amount of the ticket is, the more progressive bonus can be awarded.

As explained above, according to the betting apparatus 10 in the present embodiment, both of the progressive bonus count value in the game plays and the progressive bonus count value in the ticket sales are accumulated into the progressive bonus counter 122a. All or part of the progressive bonus count value accumulated in the progressive bonus counter 122a will be awarded to a player if the progressive bonus is awarded in the game plays or in the ticket sales. Therefore, a player can obtain more awards.

Although embodiments of the present invention have been described as above, they are only presented as concrete examples, without particularly limiting the present invention. Concrete arrangements of respective units may be changed in design as appropriate. In addition, the effects set forth in the embodiments of the present invention are merely an enumeration of the most preferred effect which occurs from the present invention, and the effects by the present invention is not limited to those set forth in the embodiments of the present invention.

For example, the case is explained in the above embodiment where games executed at the terminals 14 are the roulette game and the horse racing game. However, for example, the present invention can be applied to other games such as a bingo game and slot game.

In the above detailed description, mainly characteristic portions have been set forth so that the present invention can be understood more easily. The present invention is not limited to the embodiments set forth in the above detailed description and can be applied to other embodiments, with a wide range of applications. In addition, terms and wordings used in the present specification are used to precisely explain the present invention and are not intended to limit the interpretation of the present invention. Also, those skilled in the art will easily conceive, from the concept of the invention set forth in the present specification, other arrangements, systems or methods included in the concept of the present invention. Therefore, it should be appreciated that the scope of the claims includes equivalent arrangements without deviating from the scope of technical ideas of the present invention. In addition, the purpose of the abstract is to facilitate the Patent Office and general public institutions, or engineers in the technological field who are not familiar with patent and legal terms or specific terms to quickly evaluate technical contents and the essence of this application by simple investigation. Therefore, the abstract is not intended to limit the scope of the invention, which should be evaluated by descriptions of the scope of the claims. Furthermore, it is desirable to take into consideration the already disclosed literatures sufficiently in order to completely understand the objects and specific effects of the present invention.

The above detailed description includes processes executed by a computer. The aforementioned descriptions and expressions are described with a purpose that those skilled in the art will understand them most efficiently. In the present specification, each step used for deriving one result should be understood as a self-consistent process. Also, transmission, reception and recording of electric or magnetic signals are executed in each step. In the processes in respective steps, although such signals are expressed as bits, values, symbols, characters, terms or numerals, it should be noted that these are merely used for convenience of explanation. Additionally, although the processes in respective steps may be described using an expression common to human activities, the processes described in the present specification are executed, in principle, by a variety of devices. Furthermore, other arrangements required to execute respective steps are self-evident from the aforementioned description.

What is claimed is:

1. A betting system comprising:
a display for displaying images;
a counter for counting a count value for progressive bonus; and
a controller operable to:
(A) execute a unit game repeatedly,
accumulate the count value at each game execution, and
provide an award corresponding to all or part of the count value when the unit game has brought a winning of the progressive bonus, and
(B) sell a ticket for an expected result of a betting event,
accumulate the count value and determine
whether or not the progressive bonus is to be awarded at each ticket sale, and
provide an award corresponding to all or part of the count value when it has been determined that the progressive bonus is to be awarded.

2. The betting system according to claim 1, wherein
the controller is operable to accumulate part of a bet amount on the unit game into the count value.

3. The betting system according to claim 1, wherein
the controller is operable to accumulate part of the award provided in the unit game into the count value.

4. The betting system according to claim 1, wherein
the controller is operable to accumulate part of a wager paid for the ticket sale into the count value.

5. The betting system according to claim 1, wherein
the controller is operable to vary the award according to a wager paid for the ticket sale.

6. A betting system comprising:
a display for displaying images;
a counter for counting a count value for progressive bonus; and
a controller operable to:
(a) execute a unit game after accepting abet amount, and provide an award when the unit game has brought a winning,
(b) accumulate part of the bet amount into the counter,
(c) provide an award corresponding to all or part of the count value when the unit game has brought a progressive bonus winning,
(d) output a ticket for an expected result of a betting event after accepting a wager,
(e) accumulate part of the wager into the counter, and
(f) determine whether or not the progressive bonus is to be awarded at accepting the wager, and provide an award corresponding to all or part of the count value when it has been determined that the progressive bonus is to be awarded.

7. The betting system according to claim 6, wherein
the controller is operable to accumulate a constant percentage of the bet amount into the counter at each game execution.

8. The betting system according to claim 6, wherein
the controller is operable to accumulate a constant percentage of the wager bet at the ticket sale into the counter.

9. A controlling method of a betting system comprising:
executing unit game repeatedly, and accumulating a count value for progressive bonus counted by a counter at each game execution,
accumulating the count value at each ticket sale for an expected result of a betting event,
providing an award corresponding to all or part of the count value when the unit game has brought a progressive bonus winning, and
determining whether or not the progressive bonus is to be awarded at each ticket sale, and providing an award corresponding to all or part of the count value when it has been determined that the progressive bonus is to be awarded.

10. The controlling method according to claim 9, wherein
part of a bet amount on the unit game is accumulated into the counter.

11. The controlling method according to claim 9, wherein
part of an award provided in the unit game is accumulated into the counter.

12. The controlling method according to claim 9, wherein
part of a wager for the ticket sale is accumulated into the counter.

13. The controlling method according to claim 9, wherein
the award for the progressive bonus is varied according to a wager for the ticket sale.
